(19) United States
(12) Patent Application Publication
(10) Pub. No.: US 2023/0046818 A1
(43) Pub. Date: Feb. 16, 2023

(54) SUPERCONDUCTING MAGNET DEVICE, AND COOLING METHOD FOR SUPERCONDUCTING MAGNET DEVICE

(71) Applicants: SUMITOMO HEAVY INDUSTRIES, LTD., Tokyo (JP); Sumitomo (SHI) Cryogenics of America, Inc., Allentown, PA (US)

(72) Inventors: Yoichiro IKEYA, Tokyo (JP); Bruce R. Sloan, Schnecksville, PA (US)

(73) Assignees: SUMITOMO HEAVY INDUSTRIES, LTD., Tokyo (JP); Sumitomo (SHI) Cryogenics of America, Inc., Allentown, PA (US)

(21) Appl. No.: 17/970,602

(22) Filed: Oct. 21, 2022

Related U.S. Application Data
(63) Continuation of application No. PCT/JP2021/011607, filed on Mar. 22, 2021.
(60) Provisional application No. 63/014,685, filed on Apr. 23, 2020.

(51) Int. Cl. H01F 6/04; F25B 9/14; H01F 6/06

(52) U.S. Cl. CPC H01F 6/04; F25B 9/14; H01F 6/06

(57) ABSTRACT

A superconducting magnet device includes a superconducting coil; a radiation shield that thermally protects the superconducting coil; a main cold head that cools the superconducting coil; a sub-cold head that cools the radiation shield; a common compressor that supplies a refrigerant gas to the main cold head and the sub-cold head; a first temperature sensor that measures a temperature of the radiation shield; a second temperature sensor that measures a temperature of the superconducting coil; and a controller configured to activate the sub-cold head for initial cooling of the superconducting magnet device, stop the sub-cold head based on an output of the first temperature sensor or the second temperature sensor, and operate the main cold head in a state where the sub-cold head is stopped.

### RELATED APPLICATIONS

The contents of U.S. Patent Application No. 63/014,685, and of International Patent Application No. PCT/JP2021/011607, on the basis of each of which priority benefits are claimed in an accompanying application data sheet, are in their entirety incorporated herein by reference.

### BACKGROUND

### Technical Field

Certain embodiments of the present invention relate to a superconducting magnet device, a cryocooler, and a cooling method for the superconducting magnet device.

### Description of Related Art

In the related art, a cooling system for a superconducting magnet in which a superconducting magnet is stored in a helium tank together with a large amount of liquid helium and the entire superconducting magnet is immersed in the liquid helium is known. This is also referred to as immersion cooling. In many cases, a two-stage Gifford-McMahon (GM) cryocooler is used to recondense vaporized liquid helium.

### SUMMARY

According to an aspect of the present invention, a superconducting magnet device includes a superconducting coil; a radiation shield that thermally protects the superconducting coil; a main cold head that cools the superconducting coil; a sub-cold head that cools the radiation shield; a common compressor that supplies a refrigerant gas to the main cold head and the sub-cold head; a first temperature sensor that measures a temperature of the radiation shield; a second temperature sensor that measures a temperature of the superconducting coil; and a controller configured to activate the sub-cold head for initial cooling of the superconducting magnet device, stop the sub-cold head based on an output of the first temperature sensor or the second temperature sensor, and operate the main cold head in a state where the sub-cold head is stopped.

According to another aspect of the present invention, a superconducting magnet device includes a superconducting coil; a radiation shield that thermally protects the superconducting coil; a main cold head that cools the superconducting coil; a sub-cold head that cools the radiation shield; a common compressor that supplies a refrigerant gas to the main cold head and the sub-cold head; a first temperature sensor that measures a temperature of the radiation shield; a second temperature sensor that measures a temperature of the superconducting coil; and a controller configured to activate the sub-cold head based on an output of the first temperature sensor or the second temperature sensor while the main cold head is operated in a state where the sub-cold head is stopped.

According to a still another aspect of the present invention, there is provided a cooling method for a superconducting magnet device. The superconducting magnet device includes a superconducting coil, a radiation shield that thermally protects the superconducting coil, a main cold head that cools the superconducting coil, a sub-cold head that cools the radiation shield, and a common compressor that supplies a refrigerant gas to the main cold head and the sub-cold head. The cooling method includes activating the sub-cold head for initial cooling of the superconducting magnet device; stopping the sub-cold head based on a temperature of the radiation shield or the superconducting coil; and operating the main cold head in a state where the sub-cold head is stopped.

According to a still another aspect of the present invention, there is provided a cooling method for a superconducting magnet device. The superconducting magnet device includes a superconducting coil, a radiation shield that thermally protects the superconducting coil, a main cold head that cools the superconducting coil, a sub-cold head that cools the radiation shield, and a common compressor that supplies a refrigerant gas to the main cold head and the sub-cold head. The cooling method includes operating the main cold head in a state where the sub-cold head is stopped; and activating the sub-cold head based on a temperature of the radiation shield or the superconducting coil.

### BRIEF DESCRIPTION OF THE DRAWINGS

FIG. 1 is a view schematically showing a superconducting magnet device according to an embodiment.

FIG. 2 is a flowchart illustrating a control method for initial cooling of the superconducting magnet device according to the embodiment.

FIG. 3 is a view showing an example of a temperature profile in the initial cooling of the superconducting magnet device according to the embodiment.

FIGS. 4A to 4C are views showing a modification of an on/off timing of each cold head of a cryocooler.

FIG. 5 is a flowchart illustrating a cooling control method in a steady operation of the superconducting magnet device according to the embodiment.

FIG. 6 is a view showing an example of a temperature profile in a steady operation of the superconducting magnet device according to the embodiment.

FIG. 7 is a view schematically showing a modification of the cryocooler according to the embodiment.

FIG. 8 is a view schematically showing a modification of a sub-cold head of the cryocooler according to the embodiment.

FIG. 9A and FIG. 9B are views schematically showing another modification of the cryocooler according to the embodiment.

FIG. 10 is a view schematically showing a modification of the superconducting magnet device according to the embodiment.

### DETAILED DESCRIPTION

Against the background of the recent global decrease in helium production and the resulting increase in helium prices, research and development of a superconducting magnet device in which an amount of liquid helium used is significantly reduced as compared with so-called immersion cooling is proceeding. Generally two systems have been proposed for such a helium-saving type superconducting magnet device. One is a conduction cooling type superconducting magnet device that directly cools a superconducting coil by a cryocooler without using liquid helium for cooling the superconducting coil. The other is a type in which a superconducting coil is cooled by circulating a very small amount of the liquid helium or a cryogenic temperature helium gas. Such a superconducting magnet device is expected to play a greater role in continuing the operation of the superconducting magnet device by suppressing internal heat generation and temperature increase that may prevent the development of superconducting states in, for example, a cryocooler such as a GM cryocooler than a system of the related art that uses a large amount of the liquid helium.

It is desirable to provide cryogenic cooling in a helium-saving superconducting magnet device.

Hereinafter, embodiments for carrying out the present invention will be described in detail with reference to the drawings. In the description and drawings, the same or equivalent components, members, and processes are designated by the same reference numerals, and duplicate descriptions will be omitted as appropriate. The scales and shapes of the illustrated parts are set for convenience in order to facilitate the description, and are not to be limitedly interpreted unless otherwise specified.

The embodiments are illustrative and do not limit the scope of the present invention in any way. All features and combinations thereof described in the embodiments are not necessarily essential to the invention.

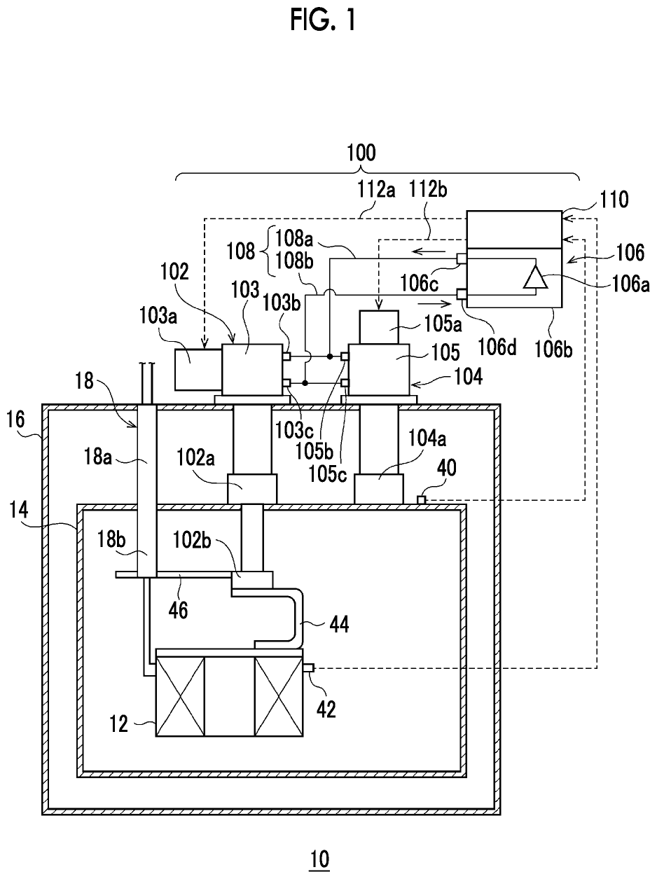

FIG. 1 is a view schematically showing a superconducting magnet device 10 according to an embodiment. The superconducting magnet device 10 is mounted on high magnetic field utilization equipment as a magnetic field source of, for example, a magnetic resonance imaging (MRI) system, a silicon single crystal pulling device using a magnetic field-applied Czochralski method, for example, an accelerator such as a cyclotron, or other high magnetic field utilization equipment and can generate a high magnetic field required for the equipment. The superconducting magnet device 10 is also referred to as a superconducting magnet.

The superconducting magnet device 10 includes a superconducting coil 12, a radiation shield 14 that thermally protects the superconducting coil 12, and a cryocooler 100 that cools the superconducting coil 12 and the radiation shield 14. In addition, the superconducting magnet device 10 includes a vacuum container 16 and a current lead 18. Further, the superconducting magnet device 10 includes a first temperature sensor 40 that measures a temperature of the radiation shield 14, and a second temperature sensor 42 that measures a temperature of the superconducting coil 12.

The superconducting coil 12 may be a known superconducting coil (for example, a so-called low-temperature superconducting coil), and is configured to generate a strong magnetic field by being energized in a state of being cooled to a cryogenic temperature equal to or lower than a superconducting transition temperature. The superconducting coil 12 is accommodated in the vacuum container 16 together with the radiation shield 14 and the current lead 18.

The radiation shield 14 is disposed so as to surround the superconducting coil 12, thereby blocking radiant heat that may enter the superconducting coil 12 from a surrounding environment (for example, a room temperature atmospheric pressure environment) or a container wall of the vacuum container 16. The radiation shield 14 is formed of a metal material such as copper or other materials having a high thermal conductivity.

The current lead 18 is installed in the superconducting magnet device 10 for connecting the superconducting coil 12 to a power supply device (not shown). The power supply device is disposed outside the vacuum container 16. The current lead 18 includes a metal current lead 18a connected to the power supply device through a feed-through portion installed in the vacuum container 16 and a superconducting current lead 18b connected to the metal current lead 18a. The superconducting current lead 18b is connected to the superconducting coil 12. The metal current lead 18a is formed of a metal material having excellent conductivity, such as copper (for example, tough pitch copper) or brass. The superconducting current lead 18b may be formed of a copper oxide superconductor or other high-temperature superconducting materials. Alternatively, the superconducting current lead 18b may be formed of a low-temperature superconducting material typified by NbTi. The current leads 18 are provided in pairs at least on a positive electrode side and a negative electrode side, and an exciting current is supplied from an external power source to the superconducting coil 12 through the current leads 18. Accordingly, the superconducting magnet device 10 can generate a strong magnetic field.

The cryocooler 100 is a Gifford-McMahon (GM) cryocooler in this embodiment. However, a general GM cryocooler operates one cold head with one compressor, but the cryocooler 100 operates two cold heads with one compressor. More specifically, the cryocooler 100 includes a main cold head 102 that cools the superconducting coil 12, a sub-cold head 104 that cools the radiation shield 14, and a common compressor 106 that supplies a refrigerant gas to the main cold head 102 and the sub-cold head 104. The cold head is also referred to as an expander. In addition, the cryocooler 100 includes a branch piping 108 that connects the main cold head 102, the sub-cold head 104, and the compressor 106, and a controller 110 that controls the cryocooler 100.

The compressor 106 is configured to recover the refrigerant gas of the cryocooler 100 from the main cold head 102 and the sub-cold head 104, pressurize the recovered refrigerant gas, and supply the refrigerant gas to these two cold heads again. The circulation of the refrigerant gas between the compressor 106 and each cold head is performed with an appropriate combination of a pressure fluctuation and a volume fluctuation of the refrigerant gas in each cold head, thereby constituting a refrigeration cycle of the cryocooler 100. Accordingly, a cooling stage of each cold head is cooled to a desired cryogenic temperature. The refrigerant gas is also referred to as a working gas and is usually a helium gas, but other appropriate gases may be used. For the sake of understanding, a flow direction of the refrigerant gas is indicated by an arrow in FIG. 1.

In general, a pressure of the refrigerant gas supplied from the compressor 106 and a pressure of the refrigerant gas recovered to the compressor 106 are both considerably higher than an atmospheric pressure and can be referred to as a first high pressure and a second high pressure, respectively. For convenience of description, the first high pressure and the second high pressure are also simply referred to as a high pressure and a low pressure, respectively. Typically, the high pressure is, for example, 2 to 3 MPa. The low pressure is, for example, 0.5 to 1.5 MPa and is, for example, about 0.8 MPa.

In this embodiment, the main cold head 102 is a two-stage cold head that cools the superconducting coil 12 and the radiation shield 14. The main cold head 102 includes a drive unit 103, a first cooling stage 102a, and a second cooling stage 102b. The drive unit 103 is mounted on the vacuum container 16 and disposed in a surrounding environment, whereas the first cooling stage 102a and the second cooling stage 102b are disposed in the vacuum container 16.

The drive unit 103 includes an electric motor 103a that drives the main cold head 102. In a case of the GM cryocooler, when the electric motor 103a is driven, a displacer and a switching valve (for example, a rotary valve) that are incorporated in the main cold head 102 operate in synchronization with each other so as to form a GM cycle. The displacer controls a volume of an expansion chamber of the refrigerant gas in the main cold head 102, and the switching valve controls a pressure of the refrigerant gas in the expansion chamber in the main cold head 102 by switching between supply and recovery of the refrigerant gas from the compressor 106. In addition, the drive unit 103 is provided with a high-pressure port 103b and a low-pressure port 103c. The main cold head 102 receives the high-pressure refrigerant gas from the high-pressure port 103b into the expansion chamber in the main cold head 102 through the switching valve and discharges the low-pressure refrigerant gas expanded in the expansion chamber from the low-pressure port 103c through the switching valve.

The main cold head 102 may be configured such that the expansion chamber in the main cold head 102 is separated from the compressor 106 when the electric motor 103a is stopped. Such a configuration is realized, for example, in a case where the switching valve of the main cold head 102 is a rotary valve, by designing the rotary valve such that there is no timing at which the expansion chamber in the main cold head 102 is simultaneously connected to both a discharge side and a suction side of the compressor 106. Alternatively, such a configuration maybe realized by stopping the rotary valve at a rotation angle selected such that the expansion chamber in the main cold head 102 is separated from both the discharge side and the suction side of the compressor 106. In this case, when the electric motor 103a is stopped, the rotary valve is stopped at the rotation angle, and the refrigerant gas does not enter or leave the main cold head 102.

The first cooling stage 102a is thermally coupled to the radiation shield 14 to cool the radiation shield 14. The first cooling stage 102a may be directly attached to the radiation shield 14, or may be connected to the radiation shield 14 via a flexible or rigid heat transfer member. In addition, the first cooling stage 102a is thermally coupled to the metal current lead 18a to cool the metal current lead 18a. In this embodiment, the metal current lead 18a is cooled via the radiation shield 14, but may be cooled via another heat transfer member or cooled by being directly attached to the first cooling stage 102a.

In this embodiment, the superconducting magnet device 10 is a conduction cooling type. The superconducting coil 12 is directly cooled by the cryocooler 100. The second cooling stage 102b of the main cold head 102 is thermally coupled to the superconducting coil 12 via a flexible or rigid heat transfer member 44 to cool the superconducting coil 12. In addition, the second cooling stage 102b is thermally coupled to the superconducting current lead 18b to cool the superconducting current lead 18b. The superconducting current lead 18b may be cooled via a heat transfer member 46 or cooled by being directly attached to the second cooling stage 102b. The second cooling stage 102b and the superconducting current lead 18b are disposed in the radiation shield 14 in the same manner as the superconducting coil 12.

The sub-cold head 104 is a single-stage cold head in this embodiment. The sub-cold head 104 includes a drive unit 105 and a cooling stage 104a. The drive unit 105 is mounted on the vacuum container 16 and disposed in a surrounding environment, and the cooling stage 104a is disposed in the vacuum container 16.

The drive unit 105 includes an electric motor 105a that drives the sub-cold head 104. In a case of the GM cryocooler, when the electric motor 105a is driven, a displacer and a switching valve (for example, a rotary valve) that are incorporated in the sub-cold head 104 operate in synchronization with each other so as to form a GM cycle. The displacer controls a volume of an expansion chamber of the refrigerant gas in the sub-cold head 104, and the switching valve controls a pressure of the refrigerant gas in the sub-cold head 104 by switching between supply and recovery of the refrigerant gas from the compressor 106. In addition, the drive unit 105 of the sub-cold head 104 is provided with a high-pressure port 105b and a low-pressure port 105c.

The sub-cold head 104 receives the high-pressure refrigerant gas from the high-pressure port 105b into the expansion chamber in the sub-cold head 104 through the switching valve, and discharges the low-pressure refrigerant gas expanded in the expansion chamber from the low-pressure port 105c through the switching valve.

The sub-cold head 104 may be configured such that the expansion chamber in the sub-cold head 104 is separated from the compressor 106 when the electric motor 105a is stopped. Such a configuration is realized, for example, in a case where the switching valve of the sub-cold head 104 is a rotary valve, by designing the rotary valve such that there is no timing at which the expansion chamber in the sub-cold head 104 is simultaneously connected to both the discharge side and the suction side of the compressor 106. Alternatively, such a configuration maybe realized by stopping the rotary valve at a rotation angle selected such that the expansion chamber in the sub-cold head 104 is separated from both the discharge side and the suction side of the compressor 106. In this case, when the electric motor 105a is stopped, the rotary valve is stopped at the rotation angle and the refrigerant gas does not enter or leave the sub-cold head 104.

The cooling stage 104a of the sub-cold head 104 is thermally coupled to the radiation shield 14 to cool the radiation shield 14. The cooling stage 104a may be directly attached to the radiation shield 14 or may be connected to the radiation shield 14 via a flexible or rigid heat transfer member. In addition, the cooling stage 104a is thermally coupled to the metal current lead 18a to cool the metal current lead 18a. In this embodiment, the metal current lead 18a is cooled via the radiation shield 14, but may be cooled via another heat transfer member or cooled by being directly attached to the cooling stage 104a. The sub-cold head 104 does not cool the superconducting coil 12.

The first cooling stage 102a of the main cold head 102 and the cooling stage 104a of the sub-cold head 104 are cooled to, for example, 30K to 80K (usually 30K to 50K, for example, 40K), and the second cooling stage 102b of the main cold head 102 is cooled to, for example, 3K to 20K (usually 3K to 4K).

All of these cooling stages are formed of a metal material such as copper or other materials having a high thermal conductivity.

The compressor 106 is disposed outside the vacuum container 16. The compressor 106 includes a compressor body 106a, a compressor casing 106b, a discharge port 106c, and a suction port 106d. The compressor body 106a is configured to internally compress the refrigerant gas sucked from a suction opening thereof and discharge the refrigerant gas from a discharge opening thereof. The compressor body 106a may be, for example, a scroll type, a rotary type, or other pumps that pressurize the refrigerant gas. The compressor body 106a may be configured to discharge a fixed constant flow rate of the refrigerant gas. Alternatively, the compressor body 106a may be configured such that a flow rate of the discharged refrigerant gas is variable. The compressor body 106a may be referred to as a compression capsule. The compressor body 106a is accommodated in the compressor casing 106b. The discharge port 106c and the suction port 106d are installed in the compressor casing 106b. The discharge port 106c is connected to the discharge opening of the compressor body 106a, and the suction port 106d is connected to the suction opening of the compressor body 106a. The compressor 106 is also referred to as a compressor unit.

The branch piping 108 includes a high-pressure-side pipe 108a and a low-pressure-side pipe 108b. The high-pressure-side pipe 108a connects the compressor 106 to the main cold head 102 and the sub-cold head 104 such that the high-pressure refrigerant gas can be supplied from the compressor 106 to both the main cold head 102 and the sub-cold head 104. The high-pressure-side pipe 108a extends from the discharge port 106c of the compressor 106, branches into two branch pipes in the middle, and is connected to each of the high-pressure port 103b of the main cold head 102 and the high-pressure port 105b of the sub-cold head 104. The low-pressure-side pipe 108b connects the main cold head 102 and the sub-cold head 104 to the compressor 106 such that the low-pressure refrigerant gas can be recovered to the compressor 106 from both the main cold head 102 and the sub-cold head 104. The low-pressure-side pipe 108b extends from each of the low-pressure port 105c of the main cold head 102 and the low-pressure port 105c of the sub-cold head 104, merges in the middle, and is connected to the suction port 106d of the compressor 106. The branch piping 108 is formed of a flexible pipe as an example, but may be formed of a rigid pipe.

The controller 110 is configured to control on/off of the main cold head 102, the sub-cold head 104, and the compressor 106 based on the output of the first temperature sensor 40 or the second temperature sensor 42, or in accordance with a command signal from a host controller (for example, a controller that controls the superconducting magnet device 10 or a host system on which the superconducting magnet device 10 is mounted). That is, the controller 110 controls on/off of the electric motor 103a of the main cold head 102 and on/off of the electric motor 105a of the sub-cold head 104. In addition, the controller 110 controls on/off of the compressor body 106a. The controller 110 can individually control on/off of the main cold head 102, the sub-cold head 104, and the compressor 106.

The controller 110 is attached to an outer surface of the compressor casing 106b or is accommodated in the compressor casing 106b. Alternatively, the controller 110 may be disposed away from the compressor 106 and may be connected to the compressor 106 by wiring. Further, the controller 110 is connected to a main power source (not shown) such as a commercial power source, and the main cold head 102 and the sub-cold head 104 are connected to the main power source by a first power supply line 112a and a second power supply line 112b, respectively. Therefore, the electric motor 103a of the main cold head 102 is supplied with power through the first power supply line 112a, and the electric motor 105a of the sub-cold head 104 is supplied with power through the second power supply line 112b.

Although details will be described later, the controller 110 is configured to activate the sub-cold head 104 for initial cooling of the superconducting magnet device 10, stop the sub-cold head 104 based on the output of the first temperature sensor 40 or the second temperature sensor 42, and operate the main cold head 102 in a state where the sub-cold head 104 is stopped. Further, the controller 110 is configured to activate the sub-cold head 104 again based on the output of the first temperature sensor 40 or the second temperature sensor 42 while the main cold head 102 is operated in a state where the sub-cold head 104 is stopped.

The controller 110 is realized by elements and circuits such as a CPU and a memory of a computer as a hardware configuration and is realized by a computer program or the like as a software configuration, but is depicted as functional blocks realized by the cooperation of these configurations as appropriate in the figure. It is understood by those skilled in the art that these functional blocks can be realized in various forms by combinations of hardware and software.

The first temperature sensor 40 is installed in the radiation shield 14 as an example, but maybe installed in another portion. For example, the first temperature sensor 40 may be installed in the first cooling stage 102a of the main cold head 102, in the cooling stage 104a of the sub-cold head 104, or in a portion (for example, the metal current lead 18a) cooled by these cooling stages. A plurality of the first temperature sensors 40 may be installed at different locations from each other. In addition, the second temperature sensor 42 is installed in the superconducting coil 12 as an example, but maybe installed in another portion. For example, the second temperature sensor 42 may be installed in the second cooling stage 102b of the main cold head 102 or in a portion (for example, the superconducting current lead 18b) cooled by the second cooling stage. A plurality of the second temperature sensors 42 maybe installed at different locations from each other.

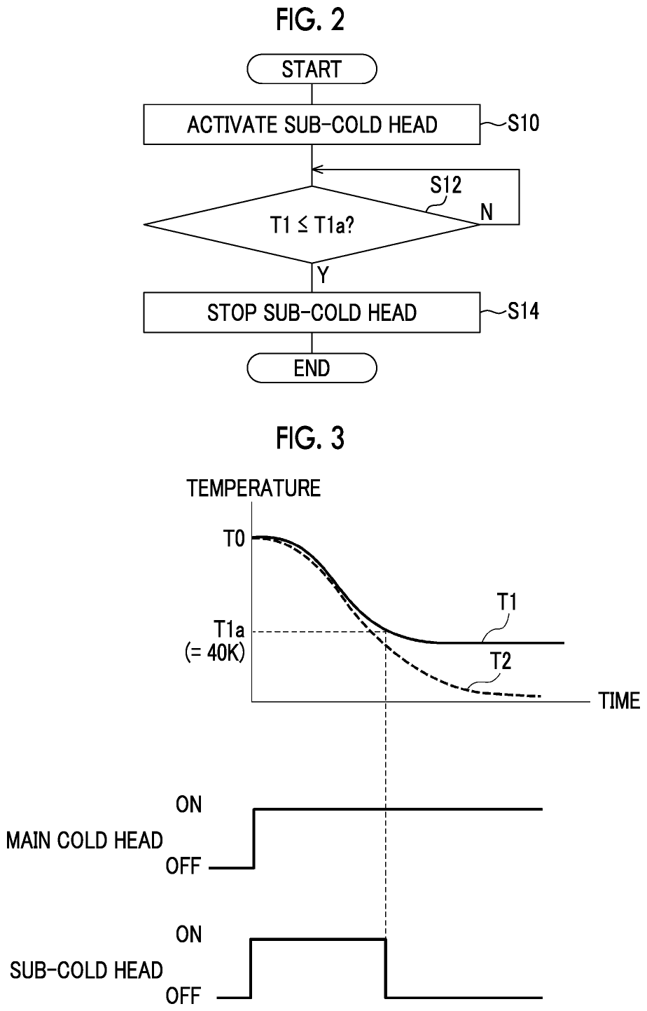

FIG. 2 is a flowchart illustrating a control method for initial cooling of the superconducting magnet device 10 according to the embodiment. A control routine illustrated in FIG. 2 is executed by the controller 110 when the superconducting magnet device 10 is activated. The controller 110 may start the control routine in response to a command signal from a host controller (for example, a controller that controls the superconducting magnet device 10). Further, the initial cooling of the superconducting magnet device 10 means cooling the superconducting coil 12 from an environmental temperature (for example, a room temperature) to a target cooling temperature (a cryogenic temperature equal to or lower than a superconducting transition temperature, for example, about 3 to 4K) when the superconducting magnet device 10 is activated.

The controller 110 activates the sub-cold head 104 for initial cooling of the superconducting magnet device 10 (S10).

That is, the controller 110 switches the electric motor 105a of the sub-cold head 104 from off to on and operates the sub-cold head 104. The controller 110 operates the compressor 106 prior to or concurrently with activating the sub-cold head 104. In this way, the cryocooler 100 starts cooling the radiation shield 14 by the sub-cold head 104.

The controller 110 receives a first sensor signal indicating a temperature measured by the first temperature sensor 40 from the first temperature sensor 40 and compares the measured temperature T1 of the first temperature sensor 40 with a target cooling temperature T1a (S12). The target cooling temperature T1a may be a temperature at which the radiation shield 14 should be maintained in the steady operation of the superconducting magnet device 10, maybe selected from, for example, a temperature range of 30K to 80K (usually 30K to 50K), and may be, for example, 40K. In a case where the measured temperature T1 of the first temperature sensor 40 exceeds the target cooling temperature T1a (N in S12), the controller 110 keeps the electric motor 105a of the sub-cold head 104 on and operates the sub-cold head 104. In this way, cooling of the radiation shield 14 by the sub-cold head 104 is continued. Then, the controller 110 compares the measured temperature T1 of the first temperature sensor 40 with the target cooling temperature T1a again (S12).

When the measured temperature T1 of the first temperature sensor 40 is equal to or lower than the target cooling temperature T1a (Y in S12), the controller 110 stops the sub-cold head 104 (S14). That is, the controller 110 switches the electric motor 105a of the sub-cold head 104 from on to off and stops the sub-cold head 104. By activating the main cold head 102 prior to or concurrently with stopping the sub-cold head 104, the controller 110 operates the main cold head 102 in a state where the sub-cold head 104 is stopped. In this way, the cryocooler 100 cools the superconducting coil 12 by the main cold head 102. Then, when the superconducting coil 12 is cooled to the target cooling temperature (for example, about 3K to 4K), the initial cooling is completed, and the superconducting magnet device 10 shifts to the steady operation.

FIG. 3 is a view showing an example of a temperature profile in the initial cooling of the superconducting magnet device 10 according to the embodiment. A vertical axis and a horizontal axis of FIG. 3 represent a temperature and a time, respectively. FIG. 3 schematically shows temporal changes in a temperature T1 of the radiation shield 14 and a temperature T2 of the superconducting coil 12. Initial values T0 of the temperature T1 of the radiation shield 14 and the temperature T2 of the superconducting coil 12 when the initial cooling is started are each, for example, 300K, and the target cooling temperatures of the radiation shield 14 and the superconducting coil 12 are, for example, 40K and 3.5K, respectively. Further, in a lower part of FIG. 3, an example of an on/off state of each cold head of the cryocooler 100 is shown.

FIG. 3 illustrates a case where the main cold head 102 is also activated when the controller 110 activates the sub-cold head 104. In this case, both the main cold head 102 and the sub-cold head 104 operate until the temperature T1 of the radiation shield 14 reaches the target cooling temperature 40K. The radiation shield 14 can be rapidly cooled by both the main cold head 102 and the sub-cold head 104.

As described above, when the temperature of the radiation shield 14 becomes equal to or lower than the target cooling temperature, the sub-cold head 104 is stopped. At this time, the superconducting coil 12 can be cooled to a temperature lower than the target cooling temperature of the radiation shield 14 according to the specifications of the superconducting magnet device 10. Alternatively, the superconducting coil 12 may not be as cold as the target cooling temperature of the radiation shield 14. In any case, the cooling of the superconducting coil 12 by the main cold head 102 is continued, and when the temperature T2 of the superconducting coil 12 reaches the target cooling temperature of 3.5K, the initial cooling of the superconducting magnet device 10 is completed.

Upon completion of the initial cooling, the superconducting magnet device 10 shifts to the steady operation. Basically, in the steady operation, the main cold head 102 operates in a state where the sub-cold head 104 is stopped, and the radiation shield 14 and the superconducting coil 12 are maintained at their respective target cooling temperatures. In the steady operation, an exciting current is supplied to the superconducting coil 12 through the current lead 18. Accordingly, the superconducting magnet device 10 can generate a strong magnetic field.

According to the embodiment, a liquid helium-free superconducting coil cooling system is realized in the superconducting magnet device 10.

In the cryocooler 100, the main cold head 102 and the sub-cold head 104 are driven by the common compressor 106. That is, a plurality of cold heads can be operated by one compressor 106. Therefore, as compared with a typical configuration in which one cold head is operated by one compressor, the cryocooler 100 according to the embodiment can reduce the number of the compressors 106, and the cost can be reduced.

Further, by activating the sub-cold head 104 in the initial cooling of the superconducting magnet device 10, a time required for the initial cooling can be shortened. If the cryocooler 100 does not have the sub-cold head 104, the initial cooling of the superconducting magnet device 10 is performed only by the main cold head 102. In this case, the initial cooling typically takes a considerably long time, for example, several days or a week or more. On the other hand, by using the sub-cold head 104 for the initial cooling, a time required to cool the radiation shield 14 can be significantly reduced, and can be shortened to, for example, about half. As a result, the time required for the initial cooling of the superconducting magnet device 10 can be shortened by one day or several days.

Further, since the sub-cold head 104 is stopped when the initial cooling is completed, the compressor 106 does not have to supply the refrigerant gas to the sub-cold head 104 thereafter. A larger amount of the refrigerant gas can be supplied from the compressor 106 to the main cold head 102, and a refrigerating capacity of the main cold head 102 can be increased.

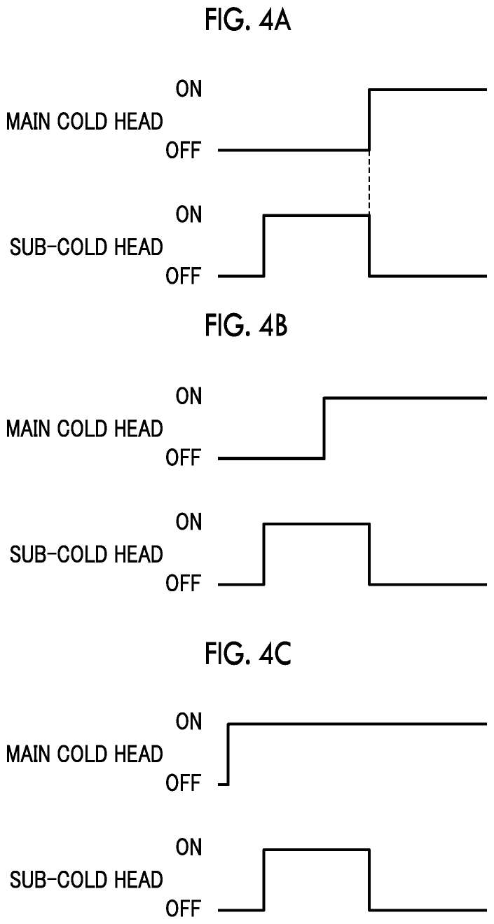

FIGS. 4A to 4C are views showing modifications of on/off timings of each cold head of the cryocooler 100. In the above-described embodiment, the main cold head 102 and the sub-cold head 104 are activated at the same time. However, the activation of the main cold head 102 may be performed at various timings.

As shown in FIG. 4A, the controller 110 may be configured to activate the main cold head 102 when the sub-cold head 104 is stopped. That is, when the radiation shield 14 is cooled to the target cooling temperature, the cooling of the superconducting magnet device 10 may be switched from the sub-cold head 104 to the main cold head 102. In this way, since the main cold head 102 is initially stopped in the initial cooling of the superconducting magnet device 10, the refrigerant gas can be intensively supplied from the compressor 106 to only the sub-cold head 104. A refrigerating capacity of the sub-cold head 104 can be increased, and the radiation shield 14 can be cooled faster.

Alternatively, as shown in FIG. 4B, the controller 110 may be configured to activate the main cold head 102 while the sub-cold head is operated. That is, while the radiation shield 14 is being cooled toward the target cooling temperature, the main cold head 102 may be activated while the sub-cold head is operated. In this way, the refrigerating capacity of the sub-cold head 104 can be increased at the beginning of the initial cooling of the superconducting magnet device 10 as in the example of FIG. 4A. In addition, the main cold head 102 can be activated and the main cold head 102 can be precooled while the radiation shield 14 is being cooled to the target cooling temperature. It is possible to smoothly shift from the stop of the sub-cold head 104 to the cooling of the superconducting coil 12 by the main cold head 102.

As shown in FIG. 4C, in some cases, the controller 110 maybe configured to activate the main cold head before activating the sub-cold head 104 (that is, in a state where the sub-cold head 104 is stopped). In this way, the superconducting coil 12 can be preferentially cooled.

In the above-described embodiment, the controller 110 is configured to stop the sub-cold head 104 based on the output of the first temperature sensor 40, but may be configured to stop the sub-cold head 104 based on the output of the second temperature sensor 42. The controller 110 may receive a second sensor signal indicating a temperature measured by the second temperature sensor 42 from the second temperature sensor 42 and compare the measured temperature of the second temperature sensor 42 with the target cooling temperature of the radiation shield 14. When the measured temperature of the second temperature sensor 42 is equal to or lower than the target cooling temperature, the controller 110 may stop the sub-cold head 104. The controller 110 may be configured to activate the main cold head 102 when the sub-cold head 104 is activated or while the sub-cold head 104 is operated, or when the sub-cold head 104 is stopped.

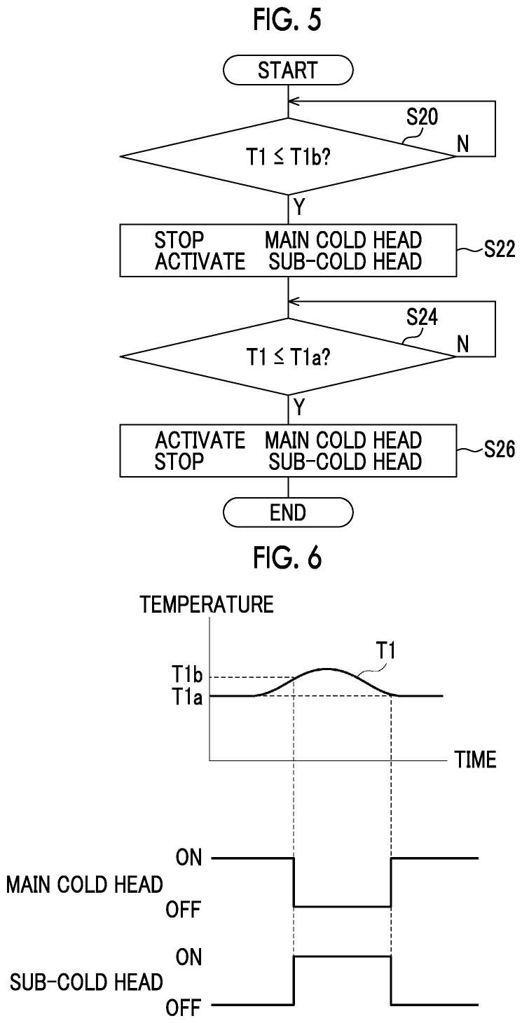

FIG. 5 is a flowchart illustrating a cooling control method in the steady operation of the superconducting magnet device 10 according to the embodiment. A control routine illustrated in FIG. 5 is executed by the controller 110 during the steady operation of the superconducting magnet device 10. When the process illustrated in FIG. 5 starts, the superconducting coil 12 and the radiation shield 14 are cooled to their respective target cooling temperatures by the main cold head 102.

When the process illustrated in FIG. 5 is started, the controller 110 receives the first sensor signal indicating the temperature measured by the first temperature sensor 40 from the first temperature sensor 40 and compares the measured temperature T1 of the first temperature sensor 40 with a warning temperature T1b (S20). For example, the measured temperature T1 of the first temperature sensor 40 may rise and deviate from the target cooling temperature T1a due to heat generation in the current lead 18 or other factors. Therefore, the warning temperature T1b is set as a temperature threshold for detecting such a temperature rise. The warning temperature T1b is set to a temperature value higher than the target cooling temperature T1a of the radiation shield 14, and may be selected from, for example, in a range of 50K to 80K. The warning temperature T1b can be appropriately set based on an empirical finding of a designer of the superconducting magnet device 10 or an experiment or simulation by the designer.

Ina case where the measured temperature T1 of the first temperature sensor 40 is equal to or lower than the warning temperature T1b (N in S20), the controller 110 keeps the electric motor 103a of the main cold head 102 on and operates the main cold head 102. In this way, the cooling of the superconducting coil 12 and the radiation shield 14 by the main cold head 102 is continued. Then, the controller 110 compares the measured temperature of the first temperature sensor 40 with the warning temperature again (S20).

When the measured temperature T1 of the first temperature sensor 40 exceeds the warning temperature T1b (Y in S20), the controller 110 stops the main cold head 102 (S22).

That is, the controller 110 switches the electric motor 103a of the main cold head 102 from on to off and stops the main cold head 102. At this time, the controller 110 activates the sub-cold head 104 at the same time as stopping the main cold head 102. That is, the controller 110 switches the electric motor 105a of the sub-cold head 104 from off to on and operates the sub-cold head 104.

The controller 110 receives the first sensor signal indicating the temperature measured by the first temperature sensor 40 from the first temperature sensor 40 and compares the measured temperature T1 of the first temperature sensor 40 with the target cooling temperature T1a (S24). In a case where the measured temperature T1 of the first temperature sensor 40 exceeds the target cooling temperature T1a (N in S24), the controller 110 keeps the electric motor 105a of the sub-cold head 104 on and operates the sub-cold head 104. In this way, cooling of the radiation shield 14 by the sub-cold head 104 is continued. Then, the controller 110 compares the measured temperature T1 of the first temperature sensor 40 with the target cooling temperature T1a again (S24).

When the measured temperature T1 of the first temperature sensor 40 is equal to or lower than the target cooling temperature T1a (Y in S24), the controller 110 stops the sub-cold head 104 (S26). That is, the controller 110 switches the electric motor 105a of the sub-cold head 104 from on to off and stops the sub-cold head 104. At this time, the controller 110 activates the main cold head 102 at the same time as stopping the sub-cold head 104. That is, the controller 110 switches the electric motor 103a of the main cold head 102 from off to on and operates the main cold head 102. In this way, the superconducting magnet device 10 returns to the original steady operation, that is, cooling of the superconducting coil 12 and the radiation shield 14 by the main cold head 102.

FIG. 6 is a view showing an example of a temperature profile in the steady operation of the superconducting magnet device 10 according to the embodiment. FIG. 6 schematically shows a temporal change in the temperature of the radiation shield 14. Further, a lower part of FIG. 6 shows an example of an on/off state of each cold head of the cryocooler 100.

As described above, the radiation shield 14 should be maintained at the target cooling temperature T1a during the steady operation, but the temperature of the radiation shield 14 may rise for some reason. When the temperature of the radiation shield 14 rises from the target cooling temperature T1a and reaches the warning temperature T1b, the main cold head 102 is stopped and the sub-cold head 104 is driven. The radiation shield 14 is cooled by the sub-cold head 104. When the temperature of the radiation shield 14 is returned to the target cooling temperature T1a or lower, the sub-cold head 104 is stopped, and the main cold head 102 is activated again. In this way, the superconducting magnet device 10 returns to the steady operation.

According to the embodiment, in the steady operation of the superconducting magnet device 10, while the main cold head 102 is operated in a state where the sub-cold head 104 is stopped, the sub-cold head 104 is activated again based on the output of the first temperature sensor 40. Accordingly, the temperature rise of the radiation shield 14 can be suppressed by cooling the sub-cold head 104, and the operation of the superconducting magnet device 10 can be continued.

Further, when the sub-cold head 104 is activated again, the main cold head 102 is stopped. Since the main cold head 102 is stopped, the compressor 106 does not have to supply the refrigerant gas to the main cold head 102 thereafter. A larger amount of the refrigerant gas can be supplied from the compressor 106 to the sub-cold head 104, and the refrigerating capacity of the sub-cold head 104 can be increased. In particular, in the steady operation of the superconducting magnet device 10, the main cold head 102 has already been cooled to a cryogenic temperature. A density of the refrigerant gas is considerably smaller under a cryogenic temperature than that at a room temperature. This means that a considerable amount of the refrigerant gas is accumulated or absorbed in the main cold head 102 as the main cold head 102 is operated. As a result, a flow rate of the refrigerant gas circulating in the cryocooler 100 decreases, and a flow rate of the refrigerant gas supplied from the compressor 106 also decreases. In such a situation, not supplying the refrigerant gas to the main cold head 102 by temporarily stopping the main cold head 102 serves to ensure the flow rate of the refrigerant gas supplied from the compressor 106 to the sub-cold head 104. In this way, the refrigerating capacity of the sub-cold head 104 can be increased, and the radiation shield 14 can be rapidly cooled.

In addition, instead of stopping the main cold head 102 when the sub-cold head 104 is activated again, the controller 110 may activate the sub-cold head 104 while operating the main cold head 102. For example, the controller 110 may continue the operation of the main cold head 102 based on the output of the second temperature sensor 42. The controller 110 may receive the second sensor signal indicating the temperature measured by the second temperature sensor 42 from the second temperature sensor 42 and compare the measured temperature of the second temperature sensor 42 with a warning temperature of the superconducting coil 12. The warning temperature of the superconducting coil 12 is higher than the target cooling temperature of the superconducting coil 12 and may be selected from, for example, a temperature range of 5K to 8K. In a case where the measured temperature of the first temperature sensor 40 exceeds a warning temperature of the radiation shield 14 and the measured temperature of the second temperature sensor 42 is equal to or lower than the warning temperature of the superconducting coil 12, the controller 110 may stop the main cold head 102 and activate the sub-cold head 104 as described above.

Alternatively, the controller 110 may temporarily stop the main cold head 102 when the sub-cold head 104 is activated again and activate the main cold head 102 again while the sub-cold head 104 is operated. For example, the controller 110 may activate the main cold head 102 again based on the output of the second temperature sensor 42 while the sub-cold head 104 is operated. The controller 110 may receive the second sensor signal indicating the temperature measured by the second temperature sensor 42 from the second temperature sensor 42 and compare the measured temperature of the second temperature sensor 42 with a warning temperature of the superconducting coil 12. Ina case where the measured temperature of the second temperature sensor 42 exceeds the warning temperature of the superconducting coil 12, the controller 110 may activate the main cold head 102 again while the sub-cold head 104 is operated.

In the above-described embodiment, both the electric motor 103a of the main cold head 102 and the electric motor 105a of the sub-cold head 104 operate at a fixed constant rotation speed, but the present invention is limited thereto. An inverter maybe mounted on at least one of the drive unit 103 of the main cold head 102 and the drive unit 105 of the sub-cold head 104 so that the rotation speed of at least one of the electric motor 103a and the electric motor 105a maybe variable. Utilizing this, an accelerated cooling function may be provided to at least one of the main cold head 102 and the sub-cold head 104.

Therefore, the controller 110 may control the rotation speed of at least one of the electric motor 103a and the electric motor 105a based on the output of the first temperature sensor 40 or the second temperature sensor 42. For example, the controller 110 may increase the rotation speed of at least one of the electric motor 103a and the electric motor 105a as the temperature measured by the first temperature sensor 40 or the second temperature sensor 42 increases. At this time, the controller 110 may control the compressor body 106a such that the flow rate of the refrigerant gas discharged from the compressor 106 increases.

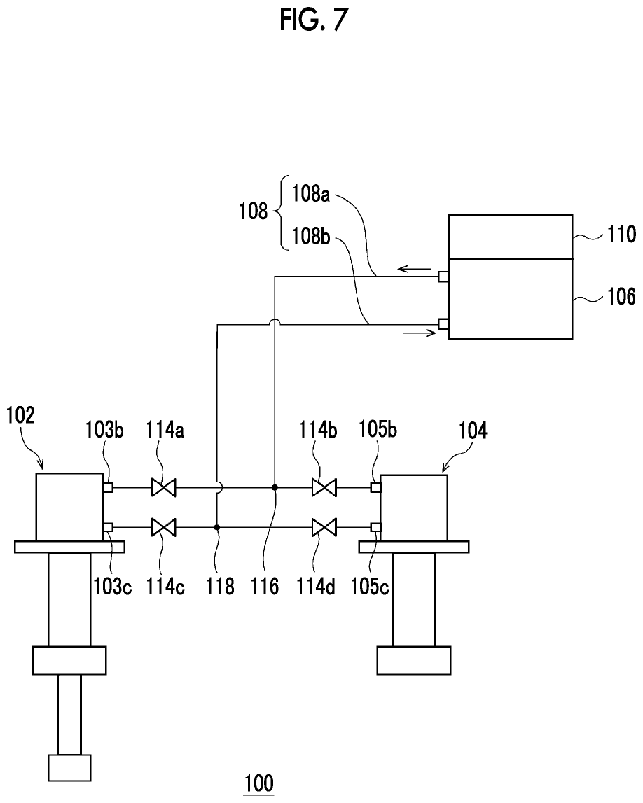

FIG. 7 is a view schematically showing a modification of the cryocooler 100 according to the embodiment. The branch piping 108 may be provided with a shutoff valve. As an example, a first shutoff valve 114a and a second shutoff valve 114b are provided in two branch pipes of the high-pressure-side pipe 108a of the branch piping 108, respectively, and a third shutoff valve 114c and a fourth shutoff valve 114d are provided in two branch pipes of the low-pressure-side pipe 108b of the branch piping 108, respectively.

That is, the first shutoff valve 114a is provided in one branch pipe of the high-pressure-side pipe 108a that connects the high-pressure port 103b of the main cold head 102 to a branch point 116 of the high-pressure-side pipe 108a, and the second shutoff valve 114b is provided in the other branch pipe of the high-pressure-side pipe 108a that connects the high-pressure port 105b of the sub-cold head 104 to the branch point 116 of the high-pressure-side pipe 108a. Further, the third shutoff valve 114c is provided in one branch pipe of the low-pressure-side pipe 108b that connects the low-pressure port 103c of the main cold head 102 to a merging point 118 of the low-pressure-side pipe 108b, and the fourth shutoff valve 114d is provided in the other branch pipe of the low-pressure-side pipe 108b that connects the low-pressure port 105c of the sub-cold head 104 to the merging point 118 of the low-pressure-side pipe 108b.

The controller 110 may be configured to open and close these shutoff valves in synchronization with on/off of the main cold head 102 and on/off of the sub-cold head 104. The first shutoff valve 114a and the third shutoff valve 114c are opened while the main cold head 102 is operated, and the first shutoff valve 114a and the third shutoff valve 114c are closed while the main cold head 102 is stopped. The second shutoff valve 114b and the fourth shutoff valve 114d are opened while the sub-cold head 104 is operated, and the second shutoff valve 114b and the fourth shutoff valve 114d are closed while the sub-cold head 104 is stopped. These shutoff valves maybe manually opened and closed in synchronization with on/off of the main cold head 102 and on/off of the sub-cold head 104.

In this way, by providing the shutoff valve in the branch pipe of the branch piping 108, it is possible to reliably disconnect the stopped cold head from the compressor 106 when any one of the cold heads is stopped. Accordingly, it is possible to prevent the refrigerant gas from being consumed by the cold head that is stopped, and it is possible to supply a larger amount of the refrigerant gas to the cold head that is operating.

In the example shown in FIG. 7, four shutoff valves are provided, but the branch piping 108 may include a smaller number of shutoff valves. For example, in order to disconnect the main cold head 102 from the compressor 106, only one of the first shutoff valve 114a and the third shutoff valve 114c may be provided. In addition, in order to disconnect the sub-cold head 104 from the compressor 106, only one of the second shutoff valve 114b and the fourth shutoff valve 114d may be provided.

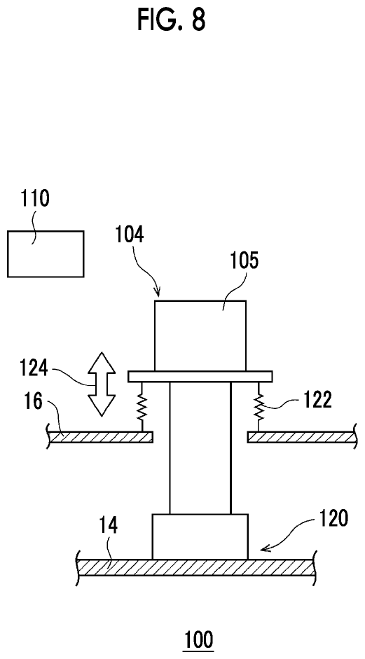

FIG. 8 is a view schematically showing a modification of the sub-cold head 104 of the cryocooler 100 according to the embodiment. The cryocooler 100 may further include a thermal switch 120 configured to bring the sub-cold head 104 into thermal contact with the radiation shield 14 or release the thermal contact.

As an example, the drive unit 105 of the sub-cold head 104 is mounted on the vacuum container 16 via a movable support structure 122 such as a vacuum. bellows. The cryocooler 100 may include a drive mechanism 124 that allows the sub-cold head 104 to move in an axial direction. The drive mechanism 124 is configured to move the sub-cold head 104 to be pushed into the vacuum container 16 or move the sub-cold head 104 to be pulled out of the vacuum container 16. The drive mechanism 124 may have an appropriate drive source such as a hydraulic source, a pneumatic source, an electric motor, and an electromagnet. Further, the sub-cold head 104 may be manually raised and lowered.

By pushing the sub-cold head 104 into the vacuum container 16, the cooling stage 104a of the sub-cold head 104 can be physically brought into contact with the radiation shield 14, and the sub-cold head 104 can be brought into thermal contact with the radiation shield 14. That is, the thermal switch 120 is turned on. By pulling the sub-cold head 104 out of the vacuum container 16, the cooling stage 104a of the sub-cold head 104 is separated from the radiation shield 14, and the thermal contact between the sub-cold head 104 and the radiation shield 14 is released. That is, the thermal switch 120 is turned off.

The controller 110 maybe configured to control on/off of the thermal switch 120 in synchronization with on/off of the sub-cold head 104. The drive mechanism 124 may be controlled to turn on the thermal switch 120 while the sub-cold head 104 is operated, and the drive mechanism 124 may be controlled to turn off the thermal switch 120 while the sub-cold head 104 is stopped.

The sub-cold head 104 is used for initial cooling of the superconducting magnet device 10, but is basically stopped during the steady operation unless a temperature rise of a component of the superconducting magnet device 10 such as the radiation shield 14 is detected. The sub-cold head 104 forms a heat transfer path from the drive unit 105 in the surrounding environment to the cooling stage 104a in the vacuum container 16 while the sub-cold head 104 is stopped.

However, by providing the thermal switch 120 on the sub-cold head 104, the sub-cold head 104 can be thermally separated from the radiation shield 14 while the sub-cold head 104 is stopped. Therefore, it is possible to reduce the heat entering the radiation shield 14 from the surrounding environment through the sub-cold head 104.

The thermal switch 120 is not limited to the type of switching on and off by mechanically moving the sub-cold head 104 as described above, and may be a thermal switch of other types. The thermal switch 120 maybe configured by, for example, a heat pipe. Alternatively, the cooling stage 104a of the sub-cold head 104 and the radiation shield 14 may be connected to each other via a pressure-adjustable gas chamber. When the gas chamber is in a high pressure, the cooling stage 104a and the radiation shield 14 are in thermal contact with each other using a gas in the gas chamber as a medium, and when the gas chamber is in a low pressure or a vacuum, the thermal contact between the cooling stage 104a and the radiation shield 14 is released.

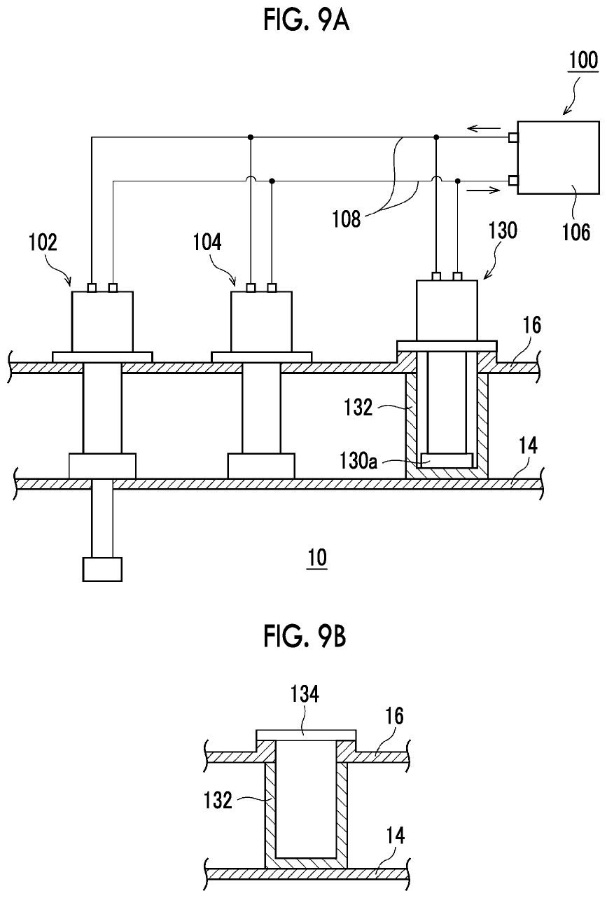

FIGS. 9A and 9B are views schematically showing another modification of the cryocooler 100 according to the embodiment. The cryocooler 100 may further include an additional sub-cold head 130 in addition to the main cold head 102 and the sub-cold head 104. The additional sub-cold head 130 is detachably connected to the compressor 106 and the branch piping 108. The additional sub-cold head 130 can be mounted on the vacuum container 16, and a mounting sleeve 132 thermally coupled to the radiation shield 14 is provided in the vacuum container 16.

As shown in FIG. 9A, for example, when a large refrigerating capacity such as for initial cooling of the superconducting magnet device 10 is required, the additional sub-cold head 130 is mounted on the mounting sleeve 132 and is connected to the compressor 106 and the branch piping 108. A cooling stage 130a of the additional sub-cold head 130 is thermally coupled to the radiation shield 14 via the mounting sleeve 132. In this way, the cryocooler 100 can cool the radiation shield 14 with two sub-cold heads. Therefore, the time required for the initial cooling can be further shortened.

As shown in FIG. 9B, when the refrigerating capacity smaller than that for the initial cooling is sufficient, for example, during the steady operation of the superconducting magnet device 10, the additional sub-cold head 130 is detached from the mounting sleeve 132 and is removed from the vacuum container 16. In addition, the additional sub-cold head 130 is also removed from the compressor 106 and the branch piping 108. When the additional sub-cold head 130 is not mounted, the mounting sleeve 132 may be sealed with a lid 134.

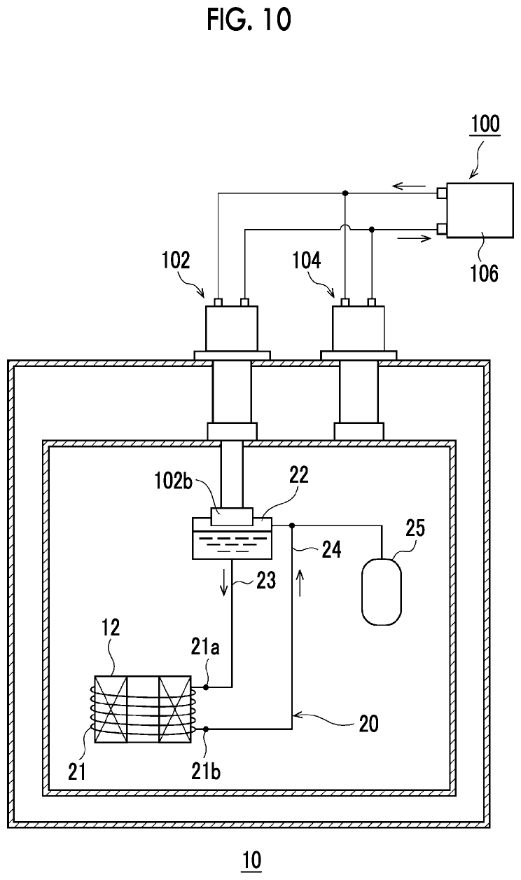

FIG. 10 is a view schematically showing a modification of the superconducting magnet device 10 according to the embodiment. The superconducting magnet device 10 illustrated in FIG. 10 is a helium-saving type device that cools the superconducting coil 12 by circulating a small amount of liquid helium. Therefore, the superconducting magnet device 10 includes a cryogenic refrigerant circuit 20 that cools the superconducting coil 12, and the cryogenic refrigerant circuit 20 together with the cryocooler 100 constitutes a superconducting coil cooling system. The cryocooler 100 includes the main cold head 102, the sub-cold head 104, and the compressor 106, as in the above-described embodiment.

The cryogenic refrigerant circuit 20 includes a cryogenic refrigerant pipe 21 disposed on a surface and/or an inside of the superconducting coil 12 and cools the superconducting coil 12 by heat exchange between the cryogenic refrigerant flowing through the cryogenic refrigerant pipe 21 and the superconducting coil 12. The cryogenic refrigerant is liquid helium. Alternatively, the cryogenic refrigerant may be a high-pressure helium gas sealed in the cryogenic refrigerant circuit 20.

In addition, the cryogenic refrigerant circuit 20 has a recondensing chamber 22 for the cryogenic refrigerant. The recondensing chamber 22 is cooled to, for example, about 3 to 4K by the main cold head 102. The recondensing chamber 22 is configured to store a liquid refrigerant therein, and a recondensing portion thermally coupled to the second cooling stage 102b of the main cold head 102 is provided on a wall of the recondensing chamber 22. The recondensing portion may include fin-like portions or irregularities inside the recondensing chamber 22 in order to increase a surface area that comes into contact with the liquid refrigerant.

The recondensing chamber 22 is connected to an inlet 21a of the cryogenic refrigerant pipe 21 by a supply pipe 23.

The cryogenic refrigerant recondensed in the recondensing chamber 22 is supplied to the cryogenic refrigerant pipe 21 through the supply pipe 23. In addition, an outlet 21b of the cryogenic refrigerant pipe 21 is connected to the recondensing chamber 22 by a return pipe 24. The cryogenic refrigerant vaporized by cooling the superconducting coil 12 returns from the cryogenic refrigerant pipe 21 to the recondensing chamber 22 through the return pipe 24 and is recondensed. A buffer volume 25 (for example, a helium gas tank) accommodating the vaporized cryogenic refrigerant may be connected to the return pipe 24.

In this way, the main cold head 102 cools the cryogenic refrigerant circuit 20 and thereby cools the superconducting coil 12. According to this embodiment, the helium-saving superconducting coil cooling system is realized in the superconducting magnet device 10. In the conventional so-called immersion cooling in which the entire superconducting coil is immersed in liquid helium to be cooled, for example, 1000 liters or more of liquid helium is used. On the other hand, in this helium-saving cooling system, for example, less than 50 liters of liquid helium circulating in the cryogenic refrigerant circuit 20 is sufficient.

The present invention has been described above based on examples. The present invention is not limited to the above-described embodiment, and it is understood by those skilled in the art that various design changes are possible, various modifications are possible, and such modifications are also within the scope of the present invention. The various features described in relation to a certain embodiment are also applicable to other embodiments. A new embodiment generated by combination of the embodiments has effects of each of the embodiments to be combined.

The main cold head 102 is not limited to a two-stage type. The main cold head 102 may be a multi-stage cold head such as a three-stage cold head, or may be a single-stage cold head as long as a required refrigerating performance can be achieved. It is not essential that the main cold head 102 is thermally coupled to the radiation shield 14, and the main cold head 102 may be separated from the radiation shield 14. Further, the sub-cold head 104 is not limited to a single-stage type. The sub-cold head 104 maybe a multi-stage cold head such as a two-stage cold head.

The cryocooler 100 is not limited to the GM cryocooler. The cryocooler 100 may be a pulse tube cryocooler, a sterling cryocooler, or other type of cryocooler.

Although the present invention has been described using specific terms and phrases based on the embodiments, the embodiments merely show one aspect of principles and applications of the present invention. Many modifications and changes in arrangement are allowed in the embodiments within the scope that does not depart from the idea of the present invention defined in the claims.

The present invention can be used in the fields of a superconducting magnet device, a cryocooler, and a cooling method for the superconducting magnet device.

It should be understood that the invention is not limited to the above-described embodiment, but may be modified into various forms on the basis of the spirit of the invention. Additionally, the modifications are included in the scope of the invention.

What is claimed is:

1. A superconducting magnet device comprising:
a superconducting coil;
a radiation shield that thermally protects the superconducting coil;
a main cold head that cools the superconducting coil;
a sub-cold head that cools the radiation shield;
a common compressor that supplies a refrigerant gas to the main cold head and the sub-cold head;
a first temperature sensor that measures a temperature of the radiation shield;
a second temperature sensor that measures a temperature of the superconducting coil; and
a controller configured to activate the sub-cold head for initial cooling of the superconducting magnet device, stop the sub-cold head based on an output of the first temperature sensor or the second temperature sensor, and operate the main cold head in a state where the sub-cold head is stopped.

2. The superconducting magnet device according to claim 1, wherein the controller is configured to activate the main cold head when the sub-cold head is activated or while the sub-cold head is operated, or when the sub-cold head is stopped.

3. The superconducting magnet device according to claim 1, wherein the controller is configured to compare the temperature measured by the first temperature sensor with a target cooling temperature and stop the sub-cold head when the measured temperature is equal to or lower than the target cooling temperature.

4. The superconducting magnet device according to claim 1, wherein the controller is configured to activate the sub-cold head again based on the output of the first temperature sensor or the second temperature sensor while the main cold head is operated in a state where the sub-cold head is stopped.

5. The superconducting magnet device according to claim 4, wherein the controller is configured to stop the main cold head when the sub-cold head is activated again.

6. The superconducting magnet device according to claim 4, wherein the controller is configured to compare the temperature measured by the first temperature sensor with a warning temperature and activate the sub-cold head again when the measured temperature exceeds the warning temperature.

7. The superconducting magnet device according claim 1, further comprising a thermal switch configured to bring the sub-cold head into thermal contact with the radiation shield or release the thermal contact.

8. The superconducting magnet device according to claim 1, further comprising:
a cryogenic refrigerant circuit that includes a cryogenic refrigerant pipe disposed on a surface and/or an inside of the superconducting coil and cools the superconducting coil by heat exchange between a cryogenic refrigerant flowing through the cryogenic refrigerant pipe and the superconducting coil,
wherein the main cold head cools the superconducting coil by cooling the cryogenic refrigerant circuit.

9. The superconducting magnet device according to claim 1, wherein the main cold head is a two-stage cold head that cools the superconducting coil and the radiation shield.

10. The superconducting magnet device according to claim 1, wherein the sub-cold head is a single-stage cold head.

11. The superconducting magnet device according to claim 1, further comprising a mounting sleeve capable of mounting an additional sub-cold head and thermally coupled to the radiation shield.

12. A superconducting magnet device comprising:
a superconducting coil;
a radiation shield that thermally protects the superconducting coil;
a main cold head that cools the superconducting coil;
a sub-cold head that cools the radiation shield;
a common compressor that supplies a refrigerant gas to the main cold head and the sub-cold head;
a first temperature sensor that measures a temperature of the radiation shield;
a second temperature sensor that measures a temperature of the superconducting coil; and
a controller configured to activate the sub-cold head based on an output of the first temperature sensor or the second temperature sensor while the main cold head is operated in a state where the sub-cold head is stopped.

13. A cooling method for a superconducting magnet device including a superconducting coil, a radiation shield that thermally protects the superconducting coil, a main cold head that cools the superconducting coil, a sub-cold head that cools the radiation shield, and a common compressor that supplies a refrigerant gas to the main cold head and the sub-cold head, the cooling method comprising:
activating the sub-cold head for initial cooling of the superconducting magnet device;
stopping the sub-cold head based on a temperature of the radiation shield or the superconducting coil; and
operating the main cold head in a state where the sub-cold head is stopped.

14. A cooling method for a superconducting magnet device including a superconducting coil, a radiation shield that thermally protects the superconducting coil, a main cold head that cools the superconducting coil, a sub-cold head that cools the radiation shield, and a common compressor that supplies a refrigerant gas to the main cold head and the sub-cold head, the cooling method comprising:
operating the main cold head in a state where the sub-cold head is stopped; and
activating the sub-cold head based on a temperature of the radiation shield or the superconducting coil.
